(19) United States
(12) Patent Application Publication
(10) Pub. No.: US 2013/0332009 A1
(43) Pub. Date: Dec. 12, 2013

(54) VEHICLE CONTROL DEVICE, VEHICLE SYSTEM, AND CONTROL METHOD

(71) Applicant: Takashi Aragai, Aichi (JP)

(72) Inventor: Takashi Aragai, Aichi (JP)

(73) Assignee: OMRON AUTOMOTIVE ELECTRONICS CO., LTD., Aichi (JP)

(21) Appl. No.: 13/915,164

(22) Filed: Jun. 11, 2013

(30) Foreign Application Priority Data
Jun. 11, 2012 (JP) 2012-132376

(51) Int. Cl. G06F 17/00

(52) U.S. Cl. CPC G06F 17/00
USPC 701/2

(57) ABSTRACT

A vehicle control device that is mounted on a vehicle including an engine has a portable key existence checking part that checks whether a portable key that can remotely control the vehicle exists in the vehicle. The portable key existence checking part stops the checking whether the portable key exists in the vehicle, when the portable key existence checking part detects an operation to cause the engine to start automatically during the checking whether the portable key exists in the vehicle, in an idling stop/start operation in which the engine is caused to stop automatically when a predetermined automatic stopping condition holds while the engine is caused to start automatically when a predetermined automatic starting condition holds.

### 1. TECHNICAL FIELD

The present invention relates to a vehicle control device, a vehicle system, and a control method, and particularly to a vehicle control device that prevents false notification on bringing-out monitoring of a portable key, a vehicle system, and a control method.

### 2. RELATED ART

Conventionally, a technology of monitoring whether a portable key (FOB) is brought out during starting of an engine is well known because the engine cannot be restarted after the engine is stopped when the portable key is brought out from the vehicle during use of the vehicle. For example, in order to monitor whether the portable key is brought out, a request signal searching the portable key is transmitted within the vehicle when the vehicle is in the use state, and a response signal is received from the portable key, thereby checking that the portable key exists in the vehicle. In this case, the request signal is periodically transmitted since the vehicle becomes in the use state, or the request signal is transmitted in the case where some sort of vehicle state or a change of the vehicle state is detected (for example, see Japanese Unexamined Patent Publication No. 2000-103316).

Nowadays, many vehicles are equipped with an idling stop function of stopping the engine while the vehicle is stopped is mounted. The monitoring whether the portable key is brought out is also performed in the vehicle equipped with the idling stop function.

For example, Japanese Unexamined Patent Publication No. 2006-214357 discloses a vehicle idling stop/start control device in order to smoothly start the engine using an idling stop/start system and to prevent degradation of a theft-proof property using a smart engine starting system. The vehicle idling stop/start control device determines a possibility of bringing out the portable key from the vehicle when the engine starts automatically using the idling stop/start system. When the vehicle idling stop/start control device determines that there is no possibility of bringing out the portable key from the vehicle, the engine is caused to start automatically without a condition that ID authentication of the portable key holds. On the other hand, when the vehicle idling stop/start control device determines that there is the possibility of bringing out the portable key from the vehicle, the engine is caused to start automatically on the condition that the ID authentication of the portable key holds.

Japanese Unexamined Patent Publication No. 2006-214358 also discloses a vehicle idling stop/start control device in order to smoothly start the engine using the idling stop/start system and to prevent the degradation of the theft-proof property using the smart engine starting system. The vehicle idling stop/start control device causes the engine to start automatically on the condition that the ID authentication of the portable key holds when the engine starts automatically using the idling stop/start system. The vehicle idling stop/start control device performs the ID authentication of the portable key even if the engine stops automatically, and the vehicle idling stop/start control device prohibits the engine from stopping automatically when the ID authentication of the portable key does not hold.

On the other hand, in the nowadays vehicle equipped with the idling stop function, when the engine is restarted, a boost part that boosts a voltage from a battery is used in order to prevent reset of a navigation system, an audio system, and the like which are mounted on the vehicle. A converter is mainly used as the boost part, and a switching noise is generated in boosting the voltage.

During the generation of the switching noise, when the request signal is transmitted in order to monitor whether the portable key is brought out, or when the response signal is received from the portable key, the transmission/reception of the signal is interrupted by an influence of the switching noise.

For example, Japanese Unexamined Patent Publication No. 2004-197649 discloses an engine control device in order to ensure high-reliability communication. The engine control device is used in the vehicle including a motor in which a high-voltage battery is used as a power source. In the vehicle, the portable key on a user side and a transmitter/receiver on a vehicle side conduct bi-directional communication. The engine control device includes an operation restricting part that restricts an operation of a switching noise generation source connected to the battery when the portable key on the user side and the transmitter/receiver on the vehicle side conduct the bi-directional communication.

However, because the restarting of the engine is required early when the engine is restarted from the idling stop state, it is not proper to restrict the operation of the voltage boost part that becomes the switching noise generation source.

In the situation in which the engine is restarted early from the idling stop state, when the transmission of a request signal making a request to monitor whether the portable key is brought out is detected during the generation of the noise caused by the restarting of the engine, the signal cannot correctly be transmitted and received, and false notification is generated even if the portable key is brought out.

### SUMMARY

One or more embodiments of the present invention provides a vehicle control device that prevents the false notification on the bringing-out monitoring of the portable key when the engine is restarted from the idling stop state, a vehicle system, and a control method.

In accordance with one aspect of the present invention, a vehicle control device that is mounted on a vehicle including an engine, includes a portable key existence checking part that checks whether a portable key that can remotely control the vehicle exists in the vehicle, wherein the portable key existence checking part stops the checking whether the portable key exists in the vehicle, when the portable key existence checking part detects an operation to cause the engine to start automatically during the checking whether the portable key exists in the vehicle, in an idling stop/start operation in which the engine is caused to stop automatically when a predetermined automatic stopping condition holds while the engine is caused to start automatically when a predetermined automatic starting condition holds.

Therefore, the vehicle control device that prevents false notification on the bringing-out monitoring of the portable key even if the idling stop/start operation automatically starts the engine at the same time as the existence of the portable key is checked can be provided in the vehicle equipped with the idling stop/start system.

The portable key existence checking part may start the checking whether the portable key exists in the vehicle when the portable key existence checking part does not detect the operation to cause the engine to start automatically after the operation is detected.

Therefore, the portable key existence checking part can return to the state in which the existence of the portable key is checked immediately after the engine is started, and the possibility of missing the bringing-out of the portable key from the vehicle can be minimized.

The portable key existence checking part may include: a request signal transmitter that transmits a request signal in order to search a position of the portable key; a response signal reception checking part that checks whether a response signal is received from the portable key after the request signal is transmitted; and a notification part that notifies a user of the vehicle that the response signal is not received when the response signal reception checking part checks that the response signal is not received, and the checking whether the portable key exists in the vehicle may be stopped by stopping a function of one of the request signal transmitter, the response signal reception checking part, and the notification part. Therefore, the generation of the false notification can be prevented according to the various parts.

The vehicle control device may further include a vehicle state detector that detects a vehicle state, wherein the portable key existence checking part checks whether the portable key exists in the vehicle when the vehicle state detector detects a predetermined vehicle state.

Therefore, whether the portable key exists in the vehicle can be checked according to the predetermined vehicle state.

The portable key existence checking part may check whether the portable key exists in the vehicle when the vehicle state detector detects that a door or a window of the vehicle is in an opened state.

Therefore, the bringing-out of the portable key can more securely be monitored by checking the existence of the portable key in the state in which the portable key is brought out from the vehicle.

The portable key existence checking part may check whether the portable key exists in the vehicle when the vehicle state detector detects that the door or the window of the vehicle becomes in a closed state from the opened state.

Therefore, the bringing-out of the portable key can more efficiently be monitored when the state in which the portable key is brought out from the vehicle becomes in the state in which the portable key is not brought out from the vehicle.

The portable key existence checking part may periodically check whether the portable key exists in the vehicle at predetermined time intervals.

Therefore, a possibility of missing the checking whether the portable key exists in the vehicle is not generated, but whether the portable key exists in the vehicle can accurately be checked.

The notification part may notifies the user of the vehicle that the response signal is not received when the response signal reception checking part does not receive the response signal the predetermined times in a row.

Therefore, the false notification can be prevented.

The notification part may end the notification, when the request signal transmitter retries transmission of the request signal predetermined times after the notification part starts the notification, and when the response signal reception checking part checks that at least one response signal is received during the retry.

Therefore, when the false notification is generated, the false notification can quickly be canceled.

The notification part may give the user of the vehicle visual notification and audible notification, the portable key existence checking part may stop the audible notification when the portable key existence checking part detects the operation to cause the engine to start while the notification part gives the user of the vehicle the visual notification and the audible notification, and the portable key existence checking part may start the audible notification when the portable key existence checking part does not detect the operation to cause the engine to start after the operation is detected.

Therefore, a user's uncomfortable situation caused by producing both sound of the restarting of the engine and sound of the audible notification can be avoided by stopping the audible notification during the restarting of the engine.

In accordance with another aspect of the present invention, a vehicle system includes: a control device that is mounted on a vehicle including an engine and checks whether a portable key that can remotely control the vehicle exists in the vehicle; an idling stop/start control device that causes the engine to stop automatically when a predetermined automatic stopping condition holds and causes the engine to start automatically when a predetermined automatic starting condition holds; and a voltage control device that boosts a voltage supplied to an instrument in the vehicle when the idling stop/start control device starts the engine, wherein the control device stops the checking whether the portable key exists in the vehicle when the voltage control device boosts the voltage.

Therefore, the vehicle system that prevents the false notification on the bringing-out monitoring of the portable key even if the starting of the engine and the checking whether the portable key exists in the vehicle are simultaneously generated can be provided.

In accordance with still another aspect of the present invention, a control device that is mounted on a vehicle including an engine and checks whether a portable key that can remotely control the vehicle exists in the vehicle, wherein, in an idling stop/start operation in which the engine is caused to stop automatically when a predetermined automatic stopping condition holds while the engine is caused to start automatically when a predetermined automatic starting condition holds, the checking whether the portable key exists in the vehicle is stopped when the engine is started while a voltage supplied to an instrument in the vehicle is boosted.

Therefore, the control device that prevents the false notification on the bringing-out monitoring of the portable key even if the starting of the engine and the checking whether the portable key exists in the vehicle are simultaneously generated can be provided.

In accordance with yet another aspect of the present invention, a control method for checking whether a portable key that can remotely control a vehicle including an engine exists in the vehicle, wherein, in an idling stop/start operation in which the engine is caused to stop automatically when a predetermined automatic stopping condition holds while the engine is caused to start automatically when a predetermined automatic starting condition holds, the checking whether the portable key exists in the vehicle is stopped when the engine is started while a voltage supplied to an instrument in the vehicle is boosted.

Therefore, the control method that prevents the false notification on the bringing-out monitoring of the portable key even if the starting of the engine and the checking whether the portable key exists in the vehicle are simultaneously generated can be provided.

As described above, one or more embodiments of the present invention can provide the vehicle control device that prevents the false notification on the bringing-out monitoring of the portable key, the vehicle system, and the control method, when the engine is restarted from the idling stop state.

### BRIEF DESCRIPTION OF THE DRAWINGS

FIG. 1 is an explanatory view illustrating a vehicle to which one or more embodiments of the present invention is applied;

FIG. 2 is a block diagram illustrating a functional configuration of a vehicle including a control device according to a first embodiment of the present invention;

FIG. 3 is a flowchart of the control device of the first embodiment;

FIG. 4 is a block diagram illustrating a functional configuration of a vehicle including a control device according to a second embodiment of the present invention;

FIGS. 5A-5D show a timing chart in the second embodiment (Part 1);

FIGS. 6A-6B show a timing chart in the second embodiment (Part 2);

FIG. 7 is a timing chart in the second embodiment (Part 3);

FIG. 8 is a timing chart in the second embodiment (Part 4);

FIG. 9 is a timing chart in the second embodiment (Part 5);

FIG. 10 is a timing chart in a modification of the second embodiment (Part 1); and

FIG. 11 is a timing chart in the modification of the second embodiment (Part 2).

### DETAILED DESCRIPTION

Hereinafter, embodiments of the present invention will be described with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

### First Embodiment

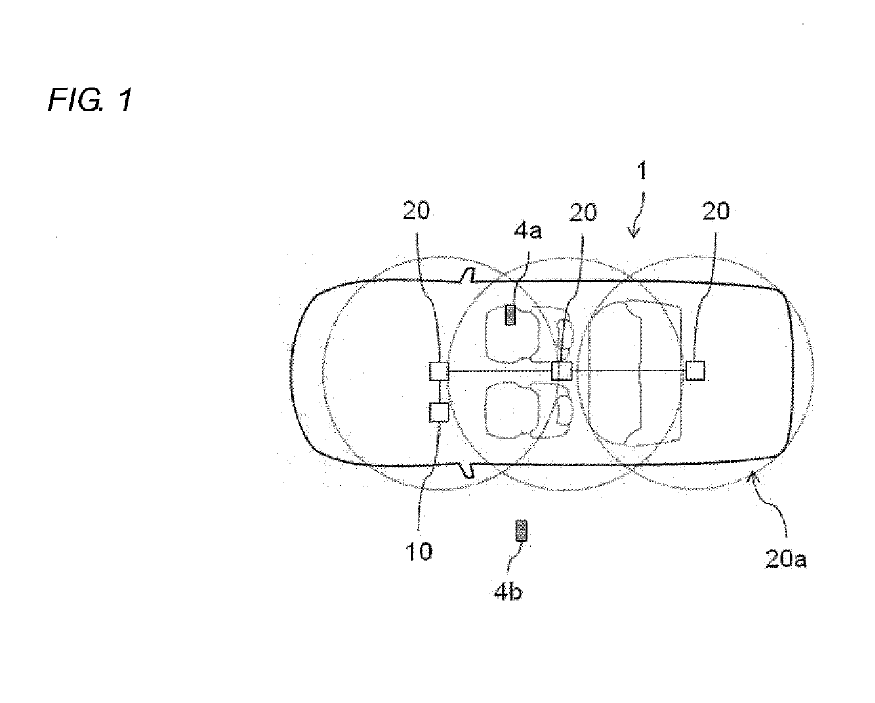

FIG. 1 illustrates a vehicle 1 to which a first embodiment of the present invention is applied. The vehicle 1 includes a vehicle control device 10 according to a first embodiment of the present invention and a communication part 20 that is controlled by the control device 10 to conduct communication with a portable key 4 (4a and 4b). The portable key 4 remotely controls the vehicle 1. For example, the portable key 4 remotely locks and unlocks a door or starts an engine.

The communication parts 20 are disposed at many places of the vehicle 1. In the first embodiment, the communication parts 20 are disposed at three places in a central portion of the vehicle 1. However, there is no particular limitation to the dispositions of the communication parts 20. Each communication part 20 has a predetermined area 20a in which a request signal making a request to receive a response from the portable key 4 can be transmitted according to intensity of an output radio wave. In the case where the portable key 4 is located within the predetermined area 20a, the portable key 4 receives the request signal from the communication part 20, and sends back a response signal in response to the request signal. When receiving the response signal sent back from the portable key 4, the communication part 20 communicates the reception of the response signal to the control device 10. When receiving that fact, the control device 10 (more specifically, a portable key existence checking part 11 (not illustrated)) determines that the portable key 4 exists within the predetermined area 20a. On the other hand, in the case where the communication part 20 does not receive the response signal from the portable key 4 after transmitting the request signal, the control device 10 determines that the portable key 4 exists out of the predetermined area 20a.

One predetermined area 20a is defined as a distance corresponding to the intensity of the radio wave from one communication part 20. The predetermined areas 20a combined by the plurality of communication parts 20 are set so as to cover the substantially whole vehicle 1 as illustrated in FIG. 1. When determining that the portable key 4 exists within one of the predetermined areas 20a, the control device 10 determines that the portable key 4 exists in the vehicle 1. For example, as illustrated in FIG. 1, because the portable key 4a exists within the predetermined area 20a, the control device 10 determines that the portable key 4a exists in the vehicle 1.

On the other hand, the portable key 4 does not exist in any predetermined areas 20a, the control device 10 determines that the portable key 4 exists out of the vehicle 1 or that the portable key 4 is brought out from the vehicle 1. For example, as illustrated in FIG. 1, because the portable key 4b does not exist in any predetermined area 20a, the control device 10 determines that the portable key 4b exists out of the vehicle 1 or that the portable key 4b is brought out from the vehicle 1. Thus, the control device 10 (the portable key existence checking part 11) checks whether the portable key 4 that can remotely control the vehicle 1 exists in the vehicle 1.

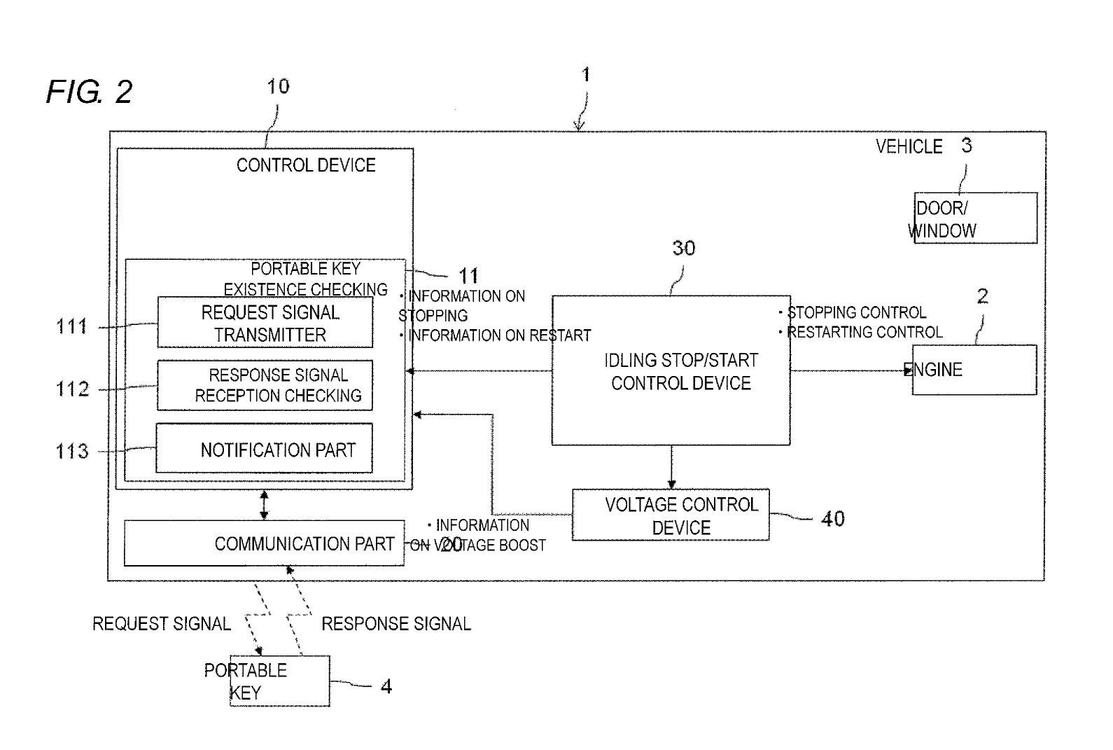

FIG. 2 is a block diagram illustrating a functional configuration of the vehicle 1 including the control device 10 of the first embodiment. The vehicle 1 includes an engine 2 that is started by a starter (not illustrated). The vehicle 1 also includes an idling stop/start control device 30. The idling stop/start control device 30 causes the engine 2 to start automatically in the case where a predetermined automatic starting condition holds, and the idling stop/start control device 30 causes the engine 2 to start automatically in the case where a predetermined automatic starting condition holds. Examples of the predetermined automatic stopping condition include parking and stopping, waiting at a stoplight, vehicle speed down, and examples of the predetermined automatic starting condition include press-down of an accelerator and release of a brake.

The idling stop/start control device 30 causes the engine 2 to stop automatically when the vehicle 1 is parked or stopped. Then the idling stop/start control device 30 causes the engine 2 to restart when the vehicle 1 is suitable for the predetermined automatic starting condition. During the restart of the engine 2, in order to prevent reset of other electronic instruments, such as an audio system and a navigation system, which are mounted on the vehicle 1, the idling stop/start control device 30 boosts a voltage supplied to the electronic instruments using a voltage control device 40. More specifically, during the restart of the engine 2, the voltage control device 40 boosts the voltage from a battery using a DC-DC converter (not illustrated).

A switching noise is generated when the DC-DC converter boosts the voltage. When the control device 10 checks the existence of the portable key 4 while the switching noise is generated, possibly the control device 10 makes a false determination. As described later, one or more embodiments of the present invention prevents the false determination.

The control device 10 includes the portable key existence checking part 11. The portable key existence checking part 11 checks whether the portable key 4 that can remotely control the vehicle 1 exists in the vehicle 1, and the portable key existence checking part 11 stops the checking whether the engine 2 exists in the vehicle 1 when an operation to automatically start the engine is detected. The portable key existence checking part 11 includes a request signal transmitter 111, a response signal reception checking part 112, and a notification part 113. Specifically, the operation to automatically start the engine is a switching operation of the DC-DC converter. However, the operation is not limited to the switching operation of the DC-DC converter. For example, the operation may be the case where the voltage is stabilized after a battery voltage fluctuation caused by cranking.

The request signal transmitter 111 transmits a request signal searching a position of the portable key 4. After the request signal transmitter 111 transmits the request signal, the response signal reception checking part 112 checks whether the response signal is received from the portable key 4. When the response signal reception checking part 112 checks that the response signal is not received, the notification part 113 notifies a user of the vehicle 1 that the response signal is not received.

For example, the communication part 20 and the portable key 4 conduct wireless communication with each other using a radio wave of an LF (Low Frequency) band or a UHF (Ultra High Frequency) band, and transmit and receive the request signal and the response signal to and from each other in addition to various instruction and pieces of information. Because the portable key 4 acts as a key of the vehicle 1, a unique communication system having excellent security is adopted as a communication system between the vehicle 1 and the portable key 4, and the communication part 20 usually authenticates the portable key 4.

For example, the request signal transmitter 111 transmits the LF-band radio wave as the request signal from the communication part 20. When the portable key 4 receives the LF-band radio wave, namely, when the portable key 4 exists in the vehicle 1, for example, the portable key 4 sends back the UHF-band radio wave as the response signal. Therefore, when receiving the response signal, the response signal reception checking part 112 determines that the portable key 4 exists in the vehicle 1. In this case, the notification part 113 does not issue a warning or an alarm.

In checking whether the portable key 4 exists in the vehicle 1, it is considered that the communication part 20 transmits the request signal at various pieces of timing. Although described in detail later, the communication part 20 may transmit the request signal as the door is opened and closed, or the communication part 20 periodically may transmit the request signal.

On the other hand, when the portable key 4 exists out of the reachable range of the LF-band radio wave, even if the request signal transmitter 111 transmits the LF-band radio wave as the request signal from the communication part 20, the response signal reception checking part 112 cannot receive the response signal from the portable key 4, but the control device 10 determines that the portable key 4 exists out of the vehicle 1. In this case, the notification part 113 issues the warning or the alarm. The notification is the correct one.

However, in the case where the time when the request signal or response signal is transmitted and received is matched with the time when the switching noise is generated in boosting the voltage, the response signal reception checking part 112 cannot receive the response signal from the portable key 4 due to interruption of the switching noise, but the control device 10 determines that the portable key 4 exists out of the vehicle 1. In this case, although the notification part 113 issues the warning or the alarm, possibly the notification is false one.

In order to remove the possibility, the control device 10 stops the checking whether the portable key 4 exists in the vehicle 1, when the control device 10 obtains the information on the restart from the idling stop/start control device 30 or when obtaining the information on the voltage boost from the voltage control device 40. Therefore, in the vehicle 1 equipped with the idling stop/start control device, there can be provided the control device 10 that prevents the false notification on the monitoring of bringing-out of the portable key 4 even if the idling stop/start control device causes the engine 2 to start automatically at the same time as the existence of the portable key 4 is checked.

More specifically, when obtaining the information on the restart from the idling stop/start control device 30, or when obtaining the information on the voltage boost from the voltage control device 40, the control device 10 stops the checking whether the portable key 4 exists in the vehicle 1 by stopping the function of one of the request signal transmitter 111, the response signal reception checking part 112, and the notification part 113.

When the request signal transmitter 111 stops the function, namely, unless the request signal transmitter 111 transmits the request signal, because the response signal reception checking part 112 does not check the existence or non-existence of the response signal from the portable key 4, the notification part 113 does not issue the warning or the alarm. When the response signal reception checking part 112 stops the function, namely, unless the response signal reception checking part 112 checks the existence or non-existence of the response signal from the portable key 4, the notification part 113 does not issue the warning or the alarm. When the notification part 113 stops the function, namely, when the notification part 113 notifies the user of nothing, the false notification is not generated. Thus, when the function of one of the request signal transmitter 111, the response signal reception checking part 112, and the notification part 113 is stopped, the false notification is not generated, but the generation of the false notification can be prevented by various parts.

After detecting the operation to cause the engine 2 to restart automatically, when the portable key existence checking part 112 does not detect the operation, the portable key existence checking part 112 starts the checking whether the portable key 4 exists in the vehicle 1. Therefore, the portable key existence checking part 112 can return to the state in which the existence of the portable key 4 is checked immediately after the engine 2 starts, and a possibility of missing the bringing-out of the portable key 4 can be minimized.

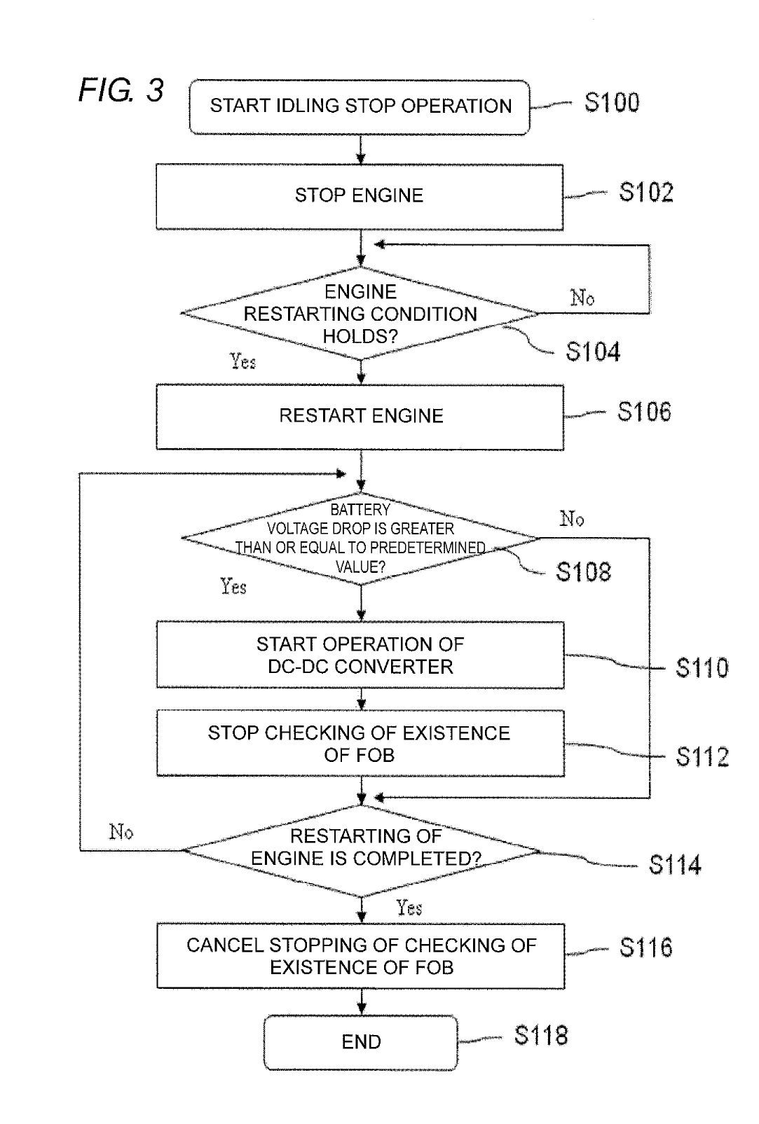

FIG. 3 is a flowchart in the control device 10 and idling stop/start control device 30 of the first embodiment. A step is abbreviated to S. In S100, as described above, the idling stop/start control device 30 starts the operation in order to perform the stopping control and the restarting control to the engine 2. In S102, the idling stop/start control device 30 causes the engine 2 to stop automatically when the vehicle 1 is parked or stopped.

In S104, the idling stop/start control device 30 continuously monitors whether an event suitable for the restarting condition of the engine 2 such that the user presses down the accelerator occurs. When the event suitable for the restarting condition of the engine 2 occurs, the idling stop/start control device 30 restarts the engine 2 in S106.

In S108, the idling stop/start control device 30 determines whether a drop in battery voltage is generated to an extent that the electronic instruments, such as the navigation system, which are mounted on the vehicle 1 are reset. When the starter is started up to start the engine 2, it is assumed that the electronic instruments are always reset, and the processing in S108 may be skipped. The idling stop/start control device 30 may directly restart the engine 2 when the drop in battery voltage is not generated to the extent that the electronic instruments are reset. On the other hand, when the drop in battery voltage is generated to the extent that the electronic instruments are reset, the idling stop/start control device 30 causes the voltage control device 40 to operate the DC-DC converter to boost the battery voltage to an extent that the electronic instruments are not reset in S110.

In this case, the control device 10 stops the checking whether the portable key (FOB) 4 exists in the vehicle 1 in S112, and the control device 10 keeps on stopping until the restarting of the engine 2 is completed (S114). Therefore, the false notification that the portable key 4 is brought out from the vehicle 1 is prevented from being issued, even if the switching noise is generated by the operation of the DC-DC converter at the same time as the request signal or the response signal is transmitted and received in order to check the existence of the portable key 4.

When the restarting of the engine 2 is completed in S114, the control device 10 immediately starts to check the existence of the portable key 4 in S116. Therefore, the possibility of missing the bringing-out of the portable key 4 from the vehicle 1 can be minimized.

The control device 10 is one that is mounted on the vehicle 1 including the engine 2 to check whether the portable key 4 that can remotely control the vehicle 1 exists in the vehicle 1. The control device 10 stops the checking whether the portable key 4 exists in the vehicle 1, when the engine 2 is started while the voltage supplied to the electronic instruments in the vehicle 1 is boosted in the idling stop/start system 30, in which the engine 2 is caused to stop automatically in the case where the predetermined automatic stopping condition holds and the engine 2 is caused to start automatically in the case where the predetermined automatic starting condition holds.

From another point of view, one or more embodiments of the present invention provides a control method for checking whether the portable key 4 that can remotely control the vehicle 1 including the engine 2 exists in the vehicle 1. In the control method, the checking whether the portable key 4 exists in the vehicle 1 is stopped, when the engine 2 is started while the voltage supplied to the electronic instruments in the vehicle 1 is boosted in the idling stop/start system 30, in which the engine 2 is caused to stop automatically in the case where the predetermined automatic stopping condition holds and the engine 2 is caused to start automatically in the case where the predetermined automatic starting condition holds.

One or more embodiments of the present invention also provides a vehicle system including the control device 10 mounted on the vehicle 1 including the engine 2, the control device 10 checking whether the portable key 4 that can remotely control the vehicle 1 including the engine 2 exists in the vehicle 1; the idling stop/start control device 30 that causes the engine 2 to stop automatically when the predetermined automatic stopping condition holds and that causes the engine 2 to start automatically when the predetermined automatic starting condition holds; and the voltage control device 40 that boosts the voltage supplied to the electronic instruments in the vehicle 1 when the idling stop/start control device 30 starts the engine 2. In the vehicle system, the control device 10 stops the checking whether the portable key 4 exists in the vehicle 1 when the voltage control device 40 boosts the voltage.

### Second Embodiment

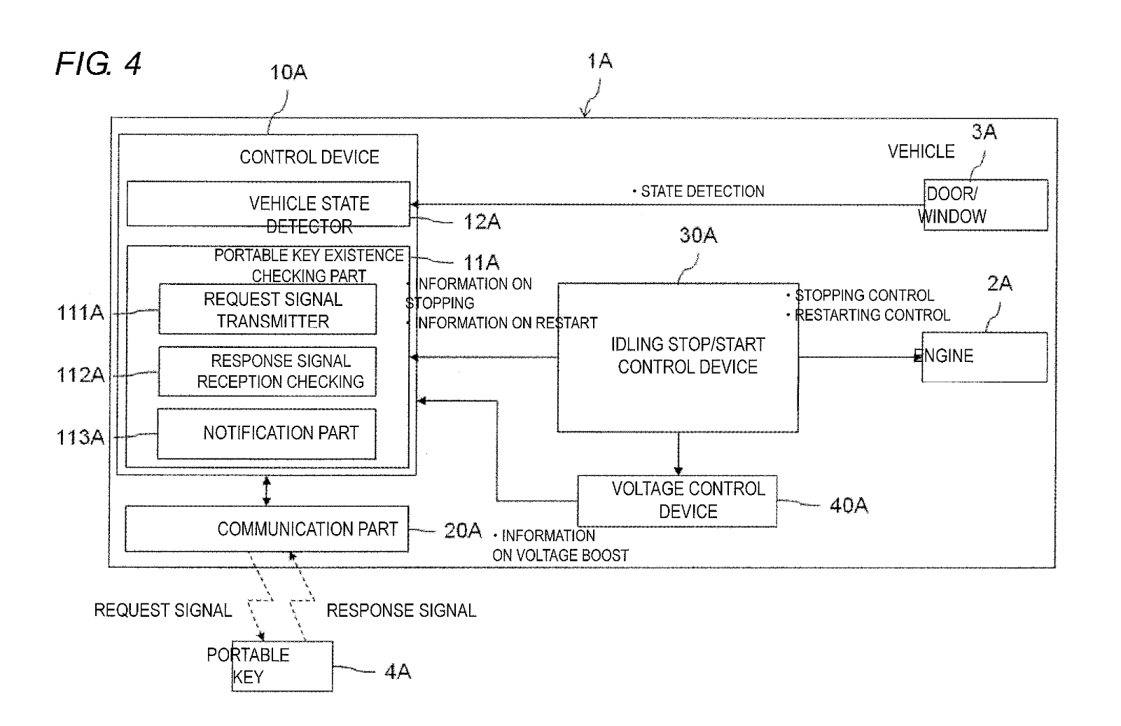

FIG. 4 is a block diagram illustrating a functional configuration of a vehicle 1A including a control device 10A according to a second embodiment. Only a point different from the first embodiment is described in order to avoid the overlapping description.

The control device 10A includes a vehicle state detector 12A that detects a vehicle state in addition to a portable key existence checking part 11A. Particularly, the vehicle state detector 12A detects a state (an opened state and a closed state) of openings, such as a door, a window, and a sun roof of the vehicle 1A, through which a portable key 4A can be brought out. The portable key existence checking part 11A checks the existence of the portable key 4A when the vehicle state detector 12A detects a predetermined vehicle state. Therefore, the existence of the portable key 4A can be checked according to the predetermined vehicle state.

As used herein, the predetermined vehicle state means the state in which possibly the portable key 4A is brought out through the openings such as the door, and typically means that the opening is in the opened state. The portable key existence checking part 11A checks the existence of the portable key 4A when the vehicle state detector 12A detects that the door or window of the vehicle 1A is in the opened state. Therefore, the bringing-out of the portable key 4A can more securely be monitored by checking the existence of the portable key 4A in the state in which the portable key 4A is brought out from the vehicle 1A.

The predetermined vehicle state includes the case where the opening becomes in the closed state from the opened state and the case where the opening becomes in the opened state from the closed state. The portable key existence checking part 11A may check the existence of the portable key 4A when the vehicle state detector 12A detects that the door or window of the vehicle 1 becomes in the closed state from the opened state. Therefore, the bringing-out of the portable key 4A can more efficiently be monitored by checking the existence of the portable key 4A, when the state in which the portable key 4A can be brought out from the vehicle becomes in the state in which the portable key 4A cannot be brought out.

In the case where the vehicle 1A is a hybrid car, the predetermined vehicle state includes a combination of the state of the opening and the state of a speed of the vehicle 1A. For example, the existence of the portable key 4A may be checked in the case where the vehicle speed is not detected (the vehicle 1A stops currently), or the existence of the portable key 4A may be checked in the case where the vehicle speed is detected (the vehicle 2A is running).

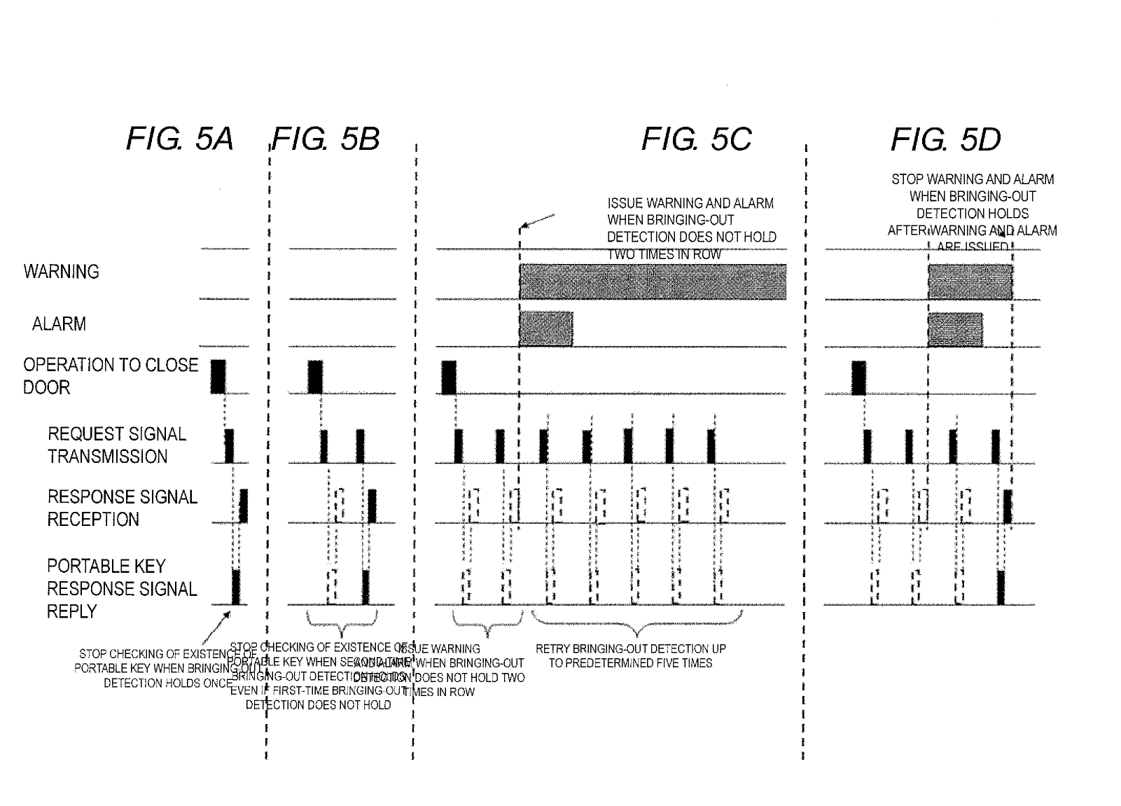

FIGS. 5A to 9 are timing charts in the control device 10A when the door becomes in the closed state from the opened state in the second embodiment. In FIG. 5A, the request signal transmitter 111A transmits the request signal when the door becomes in the closed state from the opened state. Then the portable key 4A sends back the response signal in response to the request signal. The response signal reception checking part 112A checks that the response signal is received from the portable key 4A. In the case in FIG. 5A, the control device 10A detects whether the portable key 4A is brought out once, and checks that the portable key 4A sends back the response signal. Therefore, in this case, the control device 10A checks that the bringing-out of the portable key 4A is not performed, but the notification part 113A does not issue the warning or the alarm.

In FIG. 5B, the request signal transmitter 111A transmits the request signal when the door becomes in the closed state from the opened state. However, for some reason, the portable key 4A does not send back the response signal in response to the request signal. Accordingly, the response signal reception checking part 112A does not check that the response signal is received from the portable key 4A. Then the request signal transmitter 111A transmits the request signal again. The portable key 4A sends back the response signal in response to the request signal. The response signal reception checking part 112A checks that the response signal is received from the portable key 4A. In the case in FIG. 5B, because the control device 10A does not check that the portable key 4A sends back the response signal although the control device 10A detects whether the portable key 4A is brought out once, the control device 10A successively tries the detection again, and checks that the portable key 4A sends back the response signal. Therefore, in this case, the control device 10A checks that the bringing-out of the portable key 4A is not performed, but the notification part 113A does not issue the warning or the alarm. Accordingly, although sometimes whether the portable key 4A is brought out cannot be detected by the one-time bringing-out detection, the false notification can be prevented by performing the bringing-out detection a plurality of times.

In FIG. 5C, the request signal transmitter 111A transmits the request signal when the door becomes in the closed state from the opened state. However, the portable key 4A does not send back the response signal in response to the request signal. Accordingly, the response signal reception checking part 112A does not check that the response signal is received from the portable key 4A. Then the request signal transmitter 111A transmits the request signal again. However, the portable key 4A does not send back the response signal in response to the request signal. Because the response signal reception checking part 112A cannot check that the response signal is received from the portable key 4A two times in a row, the notification part 113A issues the warning and the alarm. In the case in FIG. 5C, because the control device 10A does not successively check that the portable key 4A sends back the response signal although the control device 10A detects whether the portable key 4A is brought out twice, the control device 10A determines that the portable key 4A is brought out, and the notification part 113A issues the warning and the alarm. Therefore, the notification part 113 can surely issue the warning and the alarm when the portable key 4A is brought out. By way of caution, the request signal transmitter 111A may transmit the request signal even after the notification part 113A issues the warning and the alarm. For example, the number of retry times is set to five times.

In FIG. 5D, the request signal transmitter 111A transmits the request signal when the door becomes in the closed state from the opened state. However, the portable key 4A does not send back the response signal in response to the request signal. Accordingly, the response signal reception checking part 112A does not check that the response signal is received from the portable key 4A. Then the request signal transmitter 111A transmits the request signal again. However, the portable key 4A does not send back the response signal in response to the request signal. Because the response signal reception checking part 112A cannot check that the response signal is received from the portable key 4A two times in a row, the notification part 113A issues the warning and the alarm. However, during the retry, the portable key 4A sends back the response signal in response to the request signal, and the response signal reception checking part 112A checks that the response signal is received from the portable key 4A. Because of the checking, the notification part 113A stops the alarm and the warning. In the case in FIG. 5D, because the control device 10A does not successively check that the portable key 4A sends back the response signal although the control device 10A detects whether the portable key 4A is brought out twice, the control device 10A determines that the portable key 4A is brought out, and the notification part 113A issues the warning and the alarm. However, the notification part 113A stops the warning and the alarm because the control device 10A thereafter checks that the portable key 4A sends back the response signal. The false notification can quickly be canceled in the case where the portable key 4A is returned to the vehicle 1A.

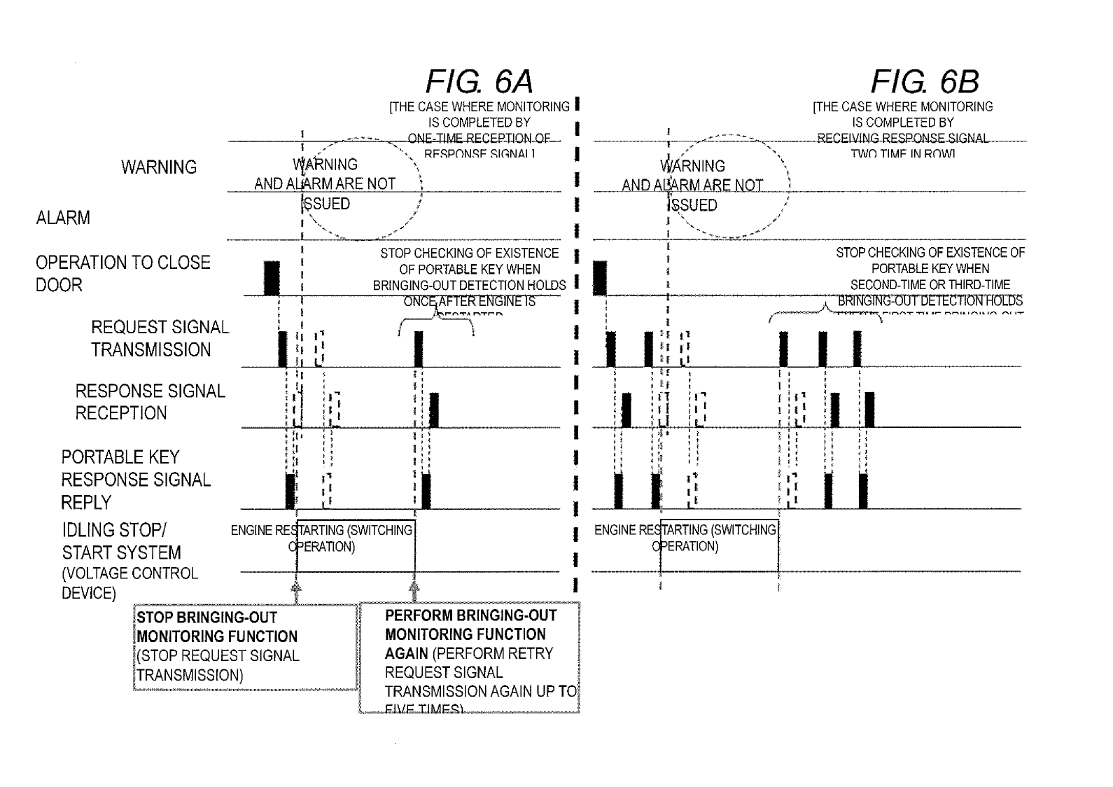

In FIG. 6A, the control device 10A detects whether the portable key is brought out only once, and the idling stop/start control device (system) 30A restarts the engine 2A. The request signal transmitter 111A transmits the request signal when the door becomes in the closed state from the opened state. Then the portable key 4A sends back the response signal in response to the request signal. At this point, the idling stop/start control device 30A restarts the engine 2A at the time the response signal reception checking part 112A receives the response signal from the portable key 4A. Therefore, the control device 10A stops the checking whether the portable key 4A exists in the vehicle 1A because the control device 10A detects the operation to cause the engine 2A to start automatically. In FIG. 6A, the function of the response signal reception checking part 112A is stopped. For this reason, the notification part 113A does not issue the warning or the alarm. Therefore, the false notification on the bringing-out monitoring of the portable key 4A can be prevented even if the idling stop/start control device 30A causes the engine 2A to start automatically at the same time as existence of the portable key 4A is checked.

After detecting the operation to cause the engine 2 to start automatically, when the portable key existence checking part 11A does not detect the operation, the portable key existence checking part 11A starts the checking whether the portable key 4A exists in the vehicle 1A. Specifically, the request signal transmitter 111A transmits the request signal, and the portable key 4A sends back the response signal in response to the request signal. The response signal reception checking part 112A checks that the portable key 4A is not brought out by checking that the response signal is received from the portable key 4A.

In FIG. 6B, the control device 10A detects whether the portable key is brought out two times in a row, and the idling stop/start control device (system) 30A restarts the engine 2A. The request signal transmitter 111A transmits the request signal when the door becomes in the closed state from the opened state. The portable key 4A sends back the response signal in response to the request signal, and the response signal reception checking part 112A checks whether the response signal is received. In FIG. 6B, because the bringing-out detection is performed two times in a row, the request signal transmitter 111A transmits the request signal. Then the portable key 4A sends back the response signal in response to the request signal. At this point, the idling stop/start control device 30A restarts the engine 2A at the time the response signal reception checking part 112A receives the response signal from the portable key 4A.

Therefore, the control device 10A stops the checking whether the portable key 4A exists in the vehicle 1A because the control device 10A detects the operation to cause the engine 2A to start automatically. In FIG. 6B, the function of the response signal reception checking part 112A is stopped. For this reason, the notification part 113A does not issue the warning or the alarm. Therefore, the false notification on the bringing-out monitoring of the portable key 4A can be prevented even if the idling stop/start control device 30A causes the engine 2A to start automatically at the same time as existence of the portable key 4A is checked.

After detecting the operation to cause the engine 2 to start automatically, when the portable key existence checking part 11A does not detect the operation, the portable key existence checking part 11A starts the checking whether the portable key 4A exists in the vehicle 1A. Specifically, similarly the response signal reception checking part 112A checks that the portable key 4A is not brought out when the existence of the portable key 4A is checked two times in a row.

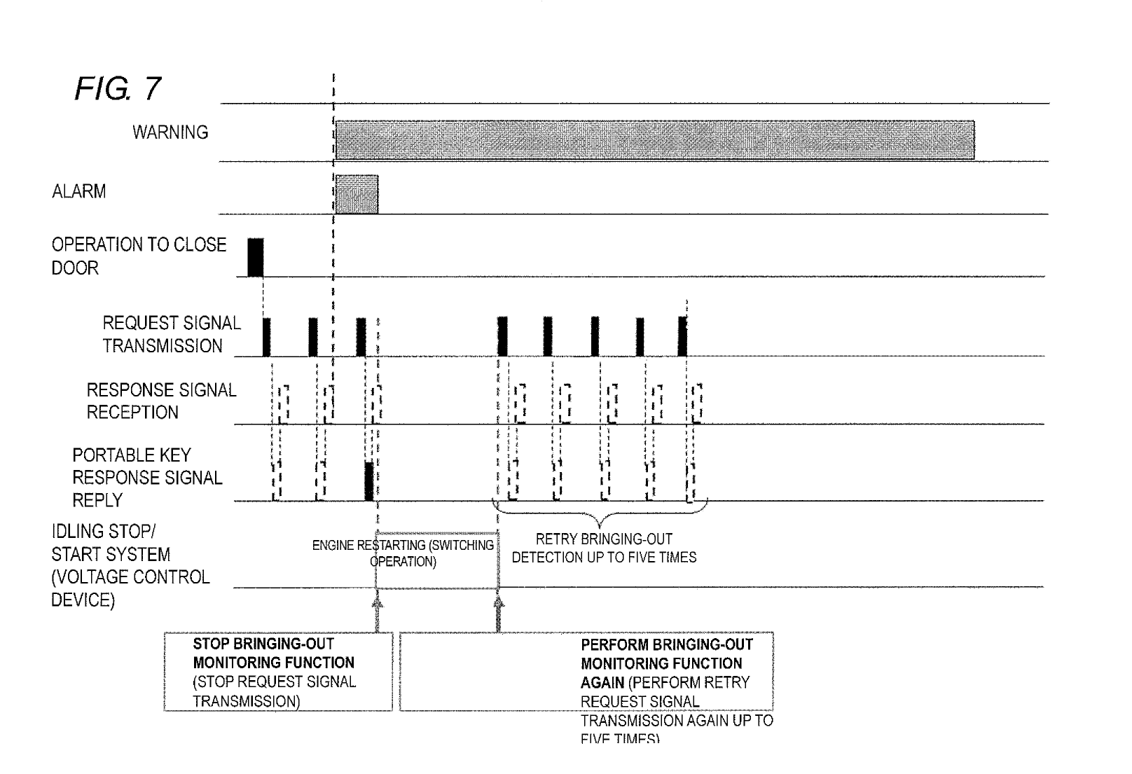

In FIG. 7, the control device 10A detects whether the portable key is brought out two times in a row, and the idling stop/start control device (system) 30A restarts the engine 2A. The request signal transmitter 111A transmits the request signal when the door becomes in the closed state from the opened state. However, the portable key 4A does not send back the response signal in response to the request signal. Accordingly, the response signal reception checking part 112A does not check that the response signal is received from the portable key 4A. Then the request signal transmitter 111A transmits the request signal again. However, the portable key 4A does not send back the response signal in response to the request signal. Because the response signal reception checking part 112A cannot check that the response signal is received from the portable key 4A two times in a row, the notification part 113A issues the warning and the alarm. Although the request signal transmitter 111A continues the retry after that, the idling stop/start control device 30A restarts the engine 2A at the time the response signal reception checking part 112A receives the response signal from the portable key 4A. Therefore, the control device 10A stops the checking whether the portable key 4A exists in the vehicle 1A because the control device 10A detects the operation to cause the engine 2A to start automatically. In this case, only the alarm may be stopped.

After detecting the operation to cause the engine 2 to start automatically, when the portable key existence checking part 11A does not detect the operation, the portable key existence checking part 11A starts the checking whether the portable key 4A exists in the vehicle 1A. In FIG. 7, even in the retry (five times) after the portable key existence checking part 11A does not detect the operation, the response signal reception checking part 112A does not receive the response signal from the portable key 4A. In this case, the number of retry times may be the remaining retry times in which the number of retry times performed before the detection of the operation is subtracted.

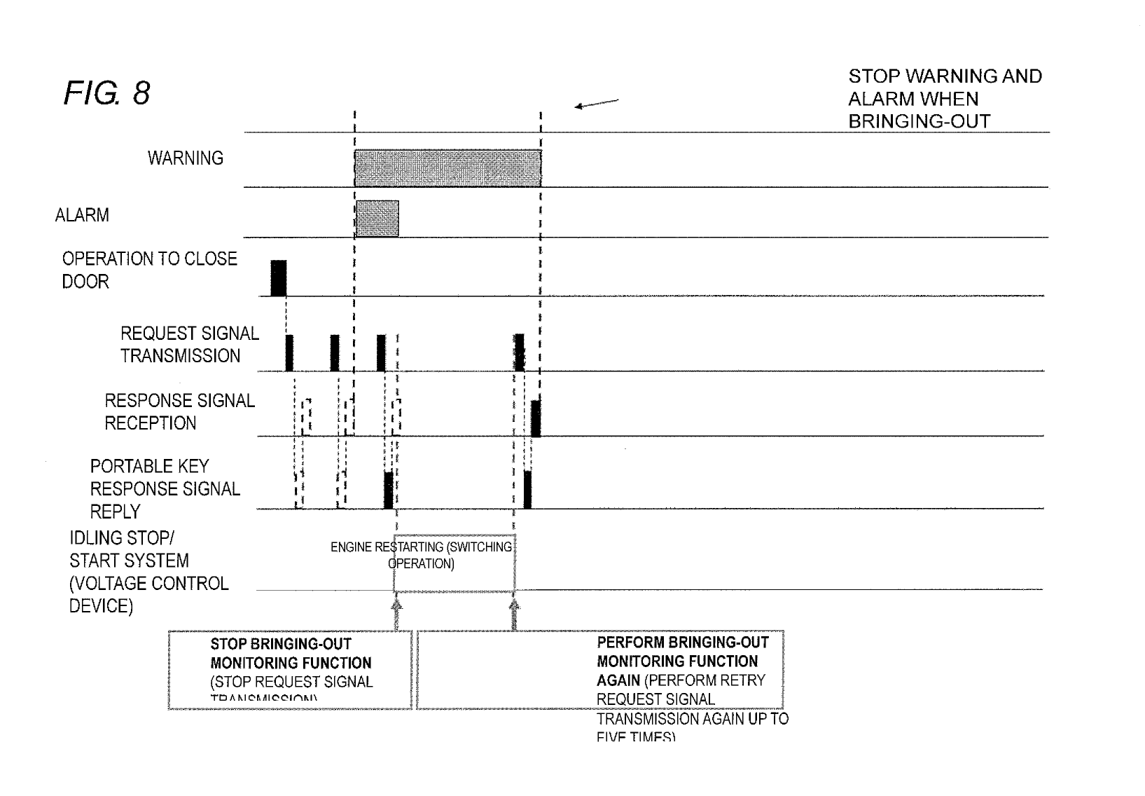

In FIG. 8, the control device 10A detects whether the portable key is brought out two times in a row, and the idling stop/start control device (system) 30A restarts the engine 2A. The request signal transmitter 111A transmits the request signal when the door becomes in the closed state from the opened state. However, the portable key 4A does not send back the response signal in response to the request signal. Accordingly, the response signal reception checking part 112A does not check that the response signal is received from the portable key 4A. Then the request signal transmitter 111A transmits the request signal again. However, the portable key 4A does not send back the response signal in response to the request signal. Because the response signal reception checking part 112A cannot check that the response signal is received from the portable key 4A two times in a row, the notification part 113A issues the warning and the alarm. Although the request signal transmitter 111A continues the retry after that, the idling stop/start control device 30A restarts the engine 2A at the time the response signal reception checking part 112A receives the response signal from the portable key 4A. Therefore, the control device 10A stops the checking whether the portable key 4A exists in the vehicle 1A because the control device 10A detects the operation to cause the engine 2A to start automatically. In this case, only the alarm may be stopped.

After detecting the operation to cause the engine 2 to start automatically, when the portable key existence checking part 11A does not detect the operation, the portable key existence checking part 11A starts the checking whether the portable key 4A exists in the vehicle 1A. In FIG. 8, the notification part 113A is stopped because the control device 10A can check that the portable key 4A is not brought out by the first-time retry after the portable key existence checking part 11A does not detect the operation. When the existence of the portable key 4A can be checked by the retry, the alarm and the warning can surely be canceled.

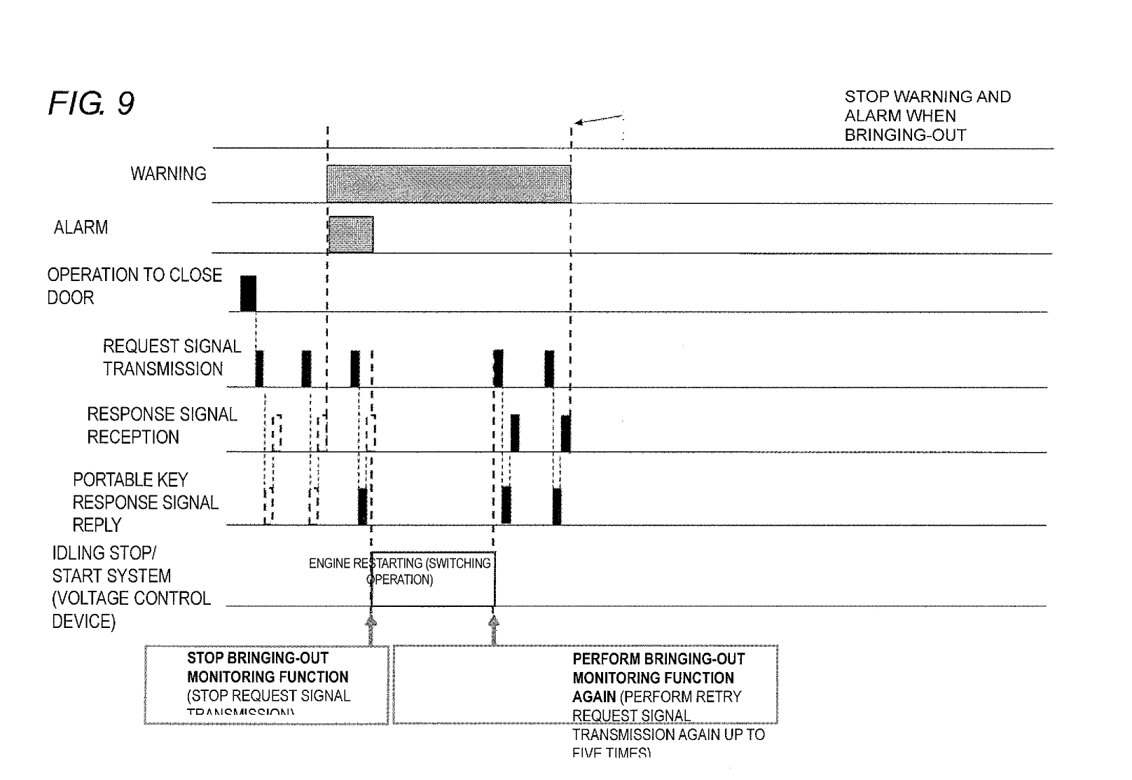

In FIG. 9, the control device 10A detects whether the portable key is brought out two times in a row, and the idling stop/start control device (system) 30A restarts the engine 2A. The request signal transmitter 111A transmits the request signal when the door becomes in the closed state from the opened state. However, the portable key 4A does not send back the response signal in response to the request signal. Accordingly, the response signal reception checking part 112A does not check that the response signal is received from the portable key 4A. Then the request signal transmitter 111A transmits the request signal again. However, the portable key 4A does not send back the response signal in response to the request signal. Because the response signal reception checking part 112A cannot check that the response signal is received from the portable key 4A two times in a row, the notification part 113A issues the warning and the alarm. Although the request signal transmitter 111A continues the retry after that, the idling stop/start control device 30A restarts the engine 2A at the time the response signal reception checking part 112A receives the response signal from the portable key 4A. Therefore, the control device 10A stops the checking whether the portable key 4A exists in the vehicle 1A because the control device 10A detects the operation to cause the engine 2A to start automatically. In this case, only the alarm may be stopped.

After detecting the operation to cause the engine 2 to start automatically, when the portable key existence checking part 11A does not detect the operation, the portable key existence checking part 11A starts the checking whether the portable key 4A exists in the vehicle 1A. In FIG. 9, the notification part 113A is stopped because the control device 10A can check that the portable key 4A is not brought out by performing the retry two times in a row after the portable key existence checking part 11A does not detect the operation. When the existence of the portable key 4A can be checked by the retry, the alarm and the warning can surely be canceled.

As described above, when the response signal reception checking part 112A checks that the response signal is not received predetermined times in a row, the notification part 113A notifies the user of the vehicle 1 that the response signal is not received. Therefore, the false notification can be prevented. After the notification part 113A starts the notification, the request signal transmitter 111A retries the transmission of the request signal predetermined times, and the response signal reception checking part 112A checks that at least one response signal is received during the retry. In this case, the notification part 113A stops the notification. Therefore, when the false notification is generated, the false notification can quickly be canceled.

The notification part 113A gives the user of the vehicle 1A visual notification and audible notification. The audible notification is stopped when the portable key existence checking part 11A detects the operation to start the engine 2A while the notification part 113A gives the user of the vehicle 1A the visual notification and the audible notification, and the audible notification may be started when the operation to start the engine 2A is not detected after the operation is detected. Therefore, a user's uncomfortable situation caused by producing both sound of the restarting of the engine 2A and sound of the audible notification can be avoided by stopping the audible notification during the restarting of the engine 2A.

The visual notification means display of the warning, and the audible notification means the alarm. The display of the warning may be lit until the response signal is received from the portable key 4A, or the display of the warning may be lit only for a predetermined time. Similarly, the alarm may be produced until the response signal is detected from the portable key 4A, or the alarm may be produced only for a predetermined time. The alarm is stopped during the restarting of the engine 2A, and the alarm may be produced for a predetermined time after the engine 2A is restarted (or only for a remaining time).

### (Modification of Second Embodiment)

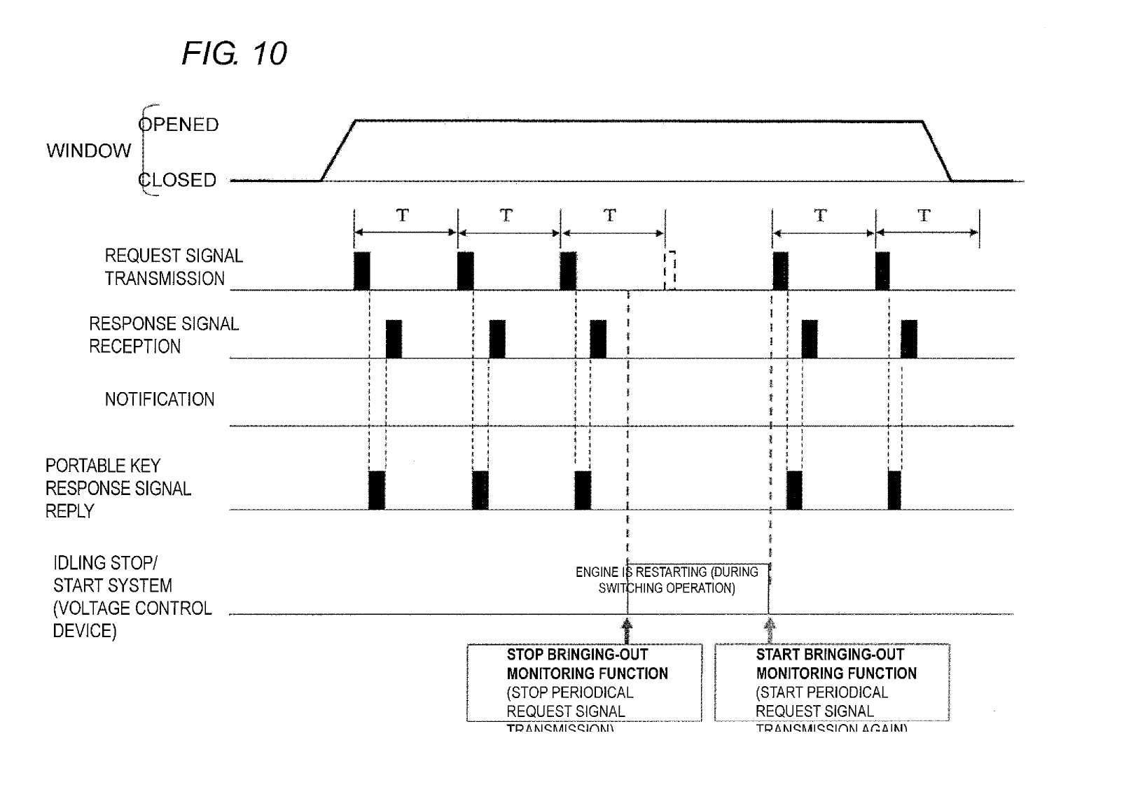

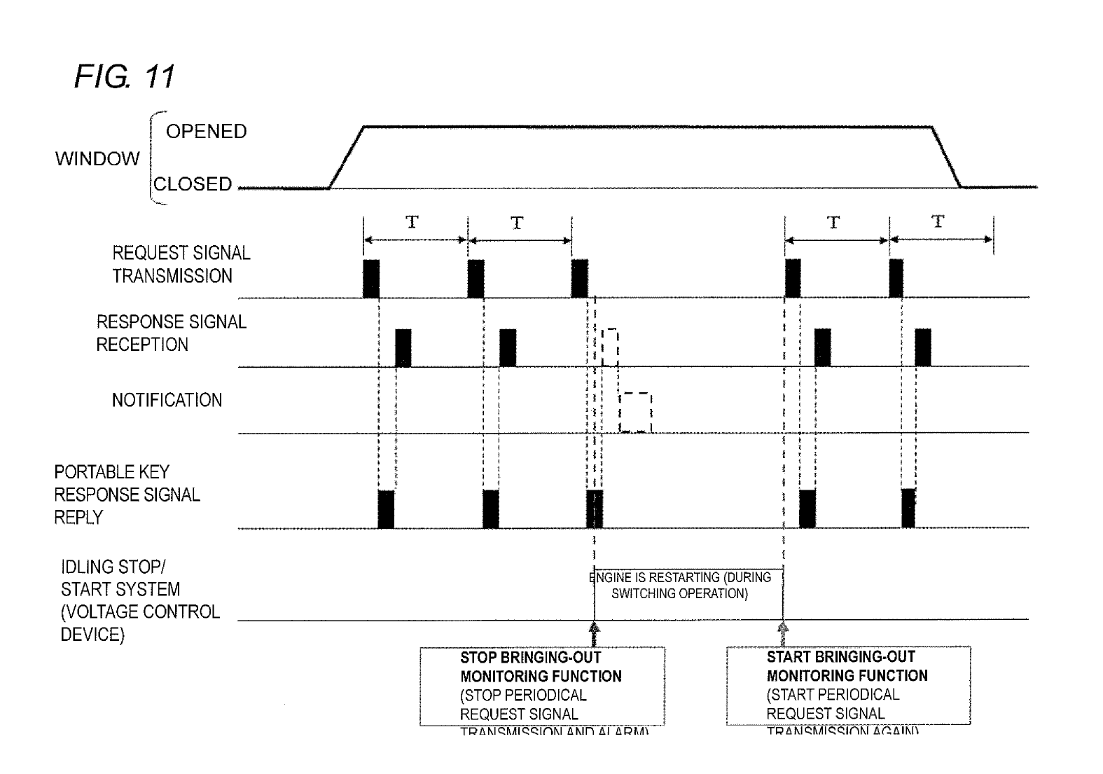

FIGS. 10 and 11 illustrate timing charts in the control device 10A when the existence of the portable key 4A is periodically checked while the openings such as the window are in the opened state in the second embodiment. In FIG. 10, the request signal transmitter 111A periodically transmits the request signal (at time intervals T). The portable key 4A sends back the response signal in response to one request signal, and the response signal reception checking part 112A checks whether the response signal is received. The possibility that the portable key 4A is brought out from the vehicle 1A increases when the opening is in the opened state. Therefore, the periodical checking is effectively performed. For example, the time interval T is 10 seconds.

In FIG. 10, the idling stop/start control device 30A restarts the engine 2A at the time the request signal transmitter 111A transmits the request signal. Therefore, the control device 10A stops the checking whether the portable key 4A exists in the vehicle 1A because the control device 10A detects the operation to cause the engine 2A to start automatically. After detecting the operation to cause the engine 2 to start automatically, when the portable key existence checking part 11A does not detect the operation, the portable key existence checking part 11A starts the checking whether the portable key 4A exists in the vehicle 1A, and starts to periodically transmit the request signal.

In FIG. 11, similarly the request signal transmitter 111A periodically transmits the request signal. The portable key 4A sends back the response signal in response to one request signal, and the response signal reception checking part 112A checks whether the response signal is received. In FIG. 11, the idling stop/start control device 30A restarts the engine 2A at the time the response signal reception checking part 112A receives the response signal from the portable key 4A. Therefore, the control device 10A stops the checking whether the portable key 4A exists in the vehicle 1A because the control device 10A detects the operation to cause the engine 2A to start automatically. Specifically, the function of the response signal reception checking part 112A is stopped. Accordingly, the notification part 113A does not issue the warning and the alarm. After detecting the operation to cause the engine 2 to start automatically, when the portable key existence checking part 11A does not detect the operation, the portable key existence checking part 11A starts the checking whether the portable key 4A exists in the vehicle 1A, and starts to periodically transmit the request signal.

As described above, irrespective of the vehicle state, the portable key existence checking part 11A may check the existence of the portable key 4A at predetermined time intervals. Therefore, the possibility of missing the checking whether the portable key 4A exists in the vehicle 1A is not generated, but the checking of the existence of the portable key 4A can accurately be performed. The existence of the portable key 4A may be checked in combination with the vehicle state. For example, the predetermined time interval means every 10 seconds or every 20 seconds. The predetermined time interval may properly be determined. Alternatively, the predetermined time interval may be determined by a speed of the vehicle 1A. For example, the existence of the portable key 4A is frequently checked in the case where the vehicle speed is zero, and the predetermined time interval is lengthened in the case where the vehicle speed is not zero.

The present invention is not limited to the above embodiments, but various modifications and changes can be made without departing from the scope of claims of the present invention. That is, although the present invention is mainly illustrated and described with respect to the specific embodiments, those skilled in the art can make various modification in a quantity and other detailed configurations without departing from the technical thought and purpose of the invention. While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A vehicle control device that is mounted on a vehicle including an engine, comprising:
a portable key existence checking part that checks whether a portable key that can remotely control the vehicle exists in the vehicle,
wherein the portable key existence checking part stops the checking whether the portable key exists in the vehicle, when the portable key existence checking part detects an operation to cause the engine to start automatically during the checking whether the portable key exists in the vehicle, in an idling stop/start operation in which the engine is caused to stop automatically when a predetermined automatic stopping condition holds while the engine is caused to start automatically when a predetermined automatic starting condition holds.

2. The vehicle control device according to claim 1, wherein the portable key existence checking part starts the checking whether the portable key exists in the vehicle when the portable key existence checking part does not detect the operation to cause the engine to start automatically after the operation is detected.

3. The vehicle control device according to claim 1,
wherein the portable key existence checking part includes:
a request signal transmitter that transmits a request signal in order to search a position of the portable key;
a response signal reception checking part that checks whether a response signal is received from the portable key after the request signal is transmitted; and
a notification part that notifies a user of the vehicle that the response signal is not received when the response signal reception checking part checks that the response signal is not received, and
wherein the checking whether the portable key exists in the vehicle is stopped by stopping a function of one of the request signal transmitter, the response signal reception checking part, and the notification part.

4. The vehicle control device according to claim 1, further comprising
a vehicle state detector that detects a vehicle state,
wherein the portable key existence checking part checks whether the portable key exists in the vehicle when the vehicle state detector detects a predetermined vehicle state.

5. The vehicle control device according to claim 4, wherein the portable key existence checking part checks whether the portable key exists in the vehicle when the vehicle state detector detects that a door or a window of the vehicle is in an opened state.

6. The vehicle control device according to claim 4, wherein the portable key existence checking part checks whether the portable key exists in the vehicle when the vehicle state detector detects that the door or the window of the vehicle becomes in a closed state from the opened state.

7. The vehicle control device according to claim 1, wherein the portable key existence checking part periodically checks whether the portable key exists in the vehicle at predetermined time intervals.

8. The vehicle control device according to claim 3, wherein the notification part notifies the user of the vehicle that the response signal is not received when the response signal reception checking part does not receive the response signal the predetermined times in a row.

9. The vehicle control device according to claim 3, wherein the notification part ends the notification, when the request signal transmitter retries transmission of the request signal predetermined times after the notification part starts the notification, and when the response signal reception checking part checks that at least one response signal is received during the retry.

10. The vehicle control device according to claim 3,
wherein the notification part gives the user of the vehicle visual notification and audible notification,
wherein the portable key existence checking part stops the audible notification when the portable key existence checking part detects the operation to cause the engine to start while the notification part gives the user of the vehicle the visual notification and the audible notification, and
wherein the portable key existence checking part starts the audible notification when the portable key existence checking part does not detect the operation to cause the engine to start after the operation is detected.

11. A vehicle system comprising:
a control device that is mounted on a vehicle including an engine and that checks whether a portable key that can remotely control the vehicle exists in the vehicle;
an idling stop/start control device that causes the engine to stop automatically when a predetermined automatic stopping condition holds and causes the engine to start automatically when a predetermined automatic starting condition holds; and
a voltage control device that boosts a voltage supplied to an instrument in the vehicle when the idling stop/start control device starts the engine,
wherein the control device stops the checking whether the portable key exists in the vehicle when the voltage control device boosts the voltage.

12. (canceled)

13. A control method comprising:
checking whether a portable key that can remotely control a vehicle including an engine exists in the vehicle,
wherein, in an idling stop/start operation in which the engine is caused to stop automatically when a predetermined automatic stopping condition holds while the engine is caused to start automatically when a predetermined automatic starting condition holds, the checking whether the portable key exists in the vehicle is stopped when the engine is started while a voltage supplied to an instrument in the vehicle is boosted.
